(19) United States
(12) Patent Application Publication
(10) Pub. No.: US 2017/0065489 A1
(43) Pub. Date: Mar. 9, 2017

(54) Breast Milk Feeding Bag or Container

(71) Applicant: Connecticut Children's Medical Center, Hartford, CT (US)

(72) Inventors: Zev H. Davidovics, West Hartford, CT (US); Jasmeet Mokha, Hartford, CT (US)

(73) Assignee: Connecticut Children's Medical Center, Hartford, CT (US)

(21) Appl. No.: 15/254,563

(22) Filed: Sep. 1, 2016

Related U.S. Application Data
(60) Provisional application No. 62/212,946, filed on Sep. 1, 2015.

(51) Int. Cl. A61J 9/00; A23L 33/00; A23L 33/10; A61J 9/06; B05B 9/04

(52) U.S. Cl. CPC A61J 9/005; A61J 9/006; A61J 9/063; B05B 9/0403; A23L 33/10; A23L 33/30; A23V 2002/00

(57) ABSTRACT

Human milk is used sparingly in infants that require g-tube feeding due to observations from studies using syringe pumps that show loss of macronutrients with continuous feeding. Macronutrient losses using human milk and elemental formula is addressed according to the present disclosure with a top-infusing feeding bag to enhance the delivery of fats, thereby encouraging more rehabilitation programs to use human milk and potentially reduce health care costs.

### CROSS-REFERENCE TO RELATED APPLICATION

The present application claims priority benefit to a provisional patent application entitled “Breast Milk Feeding Bag or Container,” which was filed on Sep. 1, 2015 and assigned Ser. No. 62/212,946. The entire content of the foregoing provisional application is incorporated herein by reference.

### BACKGROUND

Technical Field

The present disclosure is directed to systems and method for advantageous delivery of human milk to infants and, more particularly, to systems/methods that utilize a top-infusing feeding bag or container in order to improve and/or optimize fat delivery and limit losses.

Background Art

Human milk has been widely recognized as the best form of nutrition for nearly all infants.¹ Among neonates at risk for developing intestinal insufficiency (premature, low- or very low-birth weight), those fed human milk early had lower rates of complications such as necrotizing enterocolitis, retinopathy of prematurity and chronic lung disease.^{2,3} As a result, various institutional, national and international feeding guidelines recommend early enteral feeding using human milk.^{4,5} Studies also have shown advantages of human milk in infants with intestinal failure and therefore it has been recommended as the preferred nutrition in this patient population.⁶

Infants with intestinal failure are a unique patient population who are unable to sustain adequate growth and/or hydration by enteral means. In a substantial number of such infants, nutrition is often delivered via tube feedings, usually with the placement and use of a gastrostomy tube.⁶ Moreover, some of the patients tolerate continuous tube feeding better than bolus feeds.

In-vitro studies performed in the neonatal intensive care unit (NICU) in the 1980's and more recent studies have demonstrated fat and total calorie losses with tube feeding when human milk was used; the losses being the greatest with continuous feeds and with longer tube lengths.^{1,7-11} Specifically, breast milk delivered via an enteral feeding system can lose up to 30% of fat calories.

The current feeding bags dispense from a tube located at the bottom of the bag; conventional wisdom is that the lost fat adhered to the tubing. Because of this concern for fat calorie loss, many institutions only use formula and not breast milk in children that require g-tube feeding. As the test results of the present disclosure demonstrate, the fat was not lost in the tubing, but rather the fat rapidly precipitated to the top of the bag and, since the bags dispense from the bottom, the fat undesirably remained in the bag.

In view of the shortcomings of current milk feeding systems in effectively delivering fat to recipients, new milk feeding systems and/or methods are needed to reliably deliver desired levels of fat and/or calories to all infants that could benefit from g-tube feeding with breast milk, e.g., infants with intestinal failure. These and other needs are satisfied by the systems and methods disclosed herein.

### SUMMARY

The present disclosure is directed to a modified feeding bag or container for the delivery of milk (e.g., breast milk) that has an exit port, e.g., dispensing tube, positioned at or near the top of the bag/container. The disclosed modified feeding bag/container advantageously enhances the delivery of fats and calories to recipients, thereby encouraging more intestinal rehabilitation programs to use human milk, and potentially reducing health care costs. Of note, air-tight enteral feeding systems that draw/force the fluid out via pressure, e.g., the Enteralite system available from Moog, Inc., may be employed to deliver milk from the top (or near the top) to enhance fat/calorie delivery. Indeed, the noted air-tight, pressure-based systems allow for the feeding bag/container to be in any position while still allowing flow of fluid from the top (or near the top) of the bag.

In developing the advantageous feeding systems/methods of the present disclosure, it is note that the initial research goal was to determine if fat loss occurred with newer feeding bags and tubing. Surprisingly, after analyzing the fat, carbohydrate, and protein content of breast milk both before and after it passed through the enteral feeding system, it was discovered that in fact the fat was not lost in the tubing, but rather it was never leaving the bag in the first place. The fat rapidly precipitated to the top of the bag, and since the breast milk was drawn from the bottom of the bag, the precipitated fat did not leave the bag. To further test the noted hypothesis, the bag was positioned the bag upside-down so that the precipitated fat would be drawn out of the “top” of the bag, and there was no fat lost in the delivery of the breast milk.

Thus, the present disclosure is directed to a modified feeding bag/container for the delivery of breast milk that has the exit port, e.g., feeding tube, positioned at or near the top, instead of the bottom, of the bag/container. By drawing the breast milk from the top of the bag/container, fat calories are not lost, i.e., left behind in the bag/container, and children will be able to receive both optimal nutrition and the added benefits of the breast milk.

Additional features, functions and benefits associated with the disclosed systems and methods will be apparent from the description which follows, particularly when read in conjunction with the appended figures.

### BRIEF DESCRIPTION OF THE DRAWINGS

To assist those of skill in the art in understanding the disclosed systems and methods, reference is made to the appended figures wherein:

FIG. 1 shows a graph of the percent remnant fat content of human milk per hour of infusion at various rates.

FIG. 2 shows a graph of the hourly changes in fat composition at 5 mL/hr for human milk and elemental formula feeds by aliquot (control, pre- and post-infusion).

FIG. 3 shows a graph of the percent changes in human milk fat delivery per hour of infusion at 5 mL/hr with position of the feeding bag.

FIG. 4 shows a graph of the percent changes in human milk fat delivery per hour of infusion with inverted positioning of the feeding bag at various rates.

FIG. 5 is a schematic side view of an exemplary feeding bag for dispensing milk, e.g., human milk, according to the present disclosure, with the exit port/feeding tube located at (or near) the top of the bag.

### DESCRIPTION OF EXEMPLARY EMBODIMENT(S)

As noted above, the present disclosure is directed to a modified feeding bag/container for human milk, wherein the dispensing tube is located at or near the top, instead of the bottom, of the bag/container. In exemplary embodiments, the disclosed feeding bag/container may be air-tight, such that pressure may be used to force fluid/milk from the bag/container through the exit port/feeding tube and ultimately to the recipient.

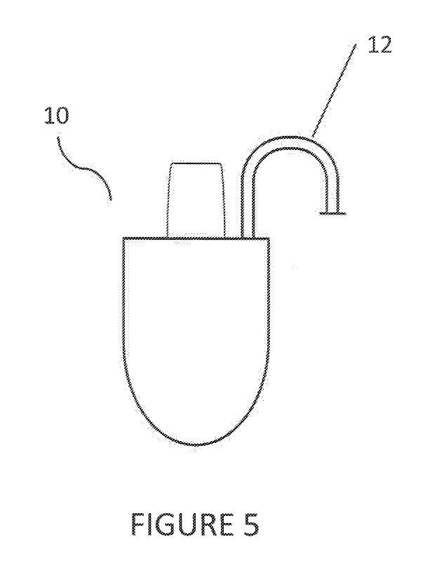

FIG. 5 provides a schematic side view of an exemplary modified feeding bag (10), wherein, the dispensing tube (12) is located at (or near) the top, instead of the bottom, of the bag. The dispensing tube (12) is connected to a pump (not pictured) and the pump functions to dispense the breast milk at a constant or varying velocity, depending on the patient's requirements. The feeding bag (10) may be suspended from a rack (not pictured) located near the patient's bed. In exemplary embodiments of the disclosed feeding bag, an airtight system is established and pressure may be used to discharge milk therefrom.

The disclosed feeding bag or container may further include a strap associated with the feeding bag that facilitates hanging thereof. The feeding bag or container is generally filled and sealed from the top. The dispensing tube may be suspended at the apex of a semicircle loop so as to avoid kinking. The dispensing tube may also be surrounded with a flexible metal coil so as to avoid kinking, e.g., a flexible spring.

Although studies reported in the literature provide convincing evidence for fat and calorie losses associated with continuous tube feedings, the systems described in the literature differ substantially from the feeding practices in rehabilitation patients on inpatient floors and in home settings. For instance, feeding bags rather than syringe-based infusion pumps are used at many institutions once the patient's feeding rate has increased past the capacity of the syringe, or they have been transferred out of the NICU. Since patients that require g-tube feeding are frequently on continuous 24 hour or overnight (8-12 hours) feeds, larger aliquots (4 hours) are prepared and infused at one time. These variables may have a significant bearing on the delivery of macronutrients, especially fats, and the resulting caloric losses could potentially affect weight gain and growth of the infant, leading to a longer hospital stay.

Therefore, in the Experimental Example that follows, losses in macronutrients (fats, carbohydrate, proteins) and total calories were examined/compared by creating simulations that reflect feeding practices utilized for rehabilitation patients as conducted on inpatient floors and at home, using human milk and elemental formula. Additionally, the effects of positioning and continuous agitation of the feeding bag on macronutrient delivery were examined.

### EXPERIMENTAL EXAMPLE

1. Experimental Method

Human milk from healthy volunteers was obtained and stored at −20 degree Celsius until analysis. All human milk donations were voluntary, pooled, and non-identifiable, and no identifying or health information for the baby or the mother was collected. Pooled human milk was thawed overnight at 4 degree Celsius and warmed to a temperature of 25 degree Celsius in an incubator on the day of the experiments. In-vitro continuous tube feeding simulations at rates of 5, 10, 20 and 30 mL/hr for 4 hours were created using the following DEHP- and PVC-free equipment: EnteraLite Infinity pump (Moog Inc., East Aurora, N.Y.), 500 mL EnteraLite feeding bags (100 mL bags were used for the 5 mL/hr. stimulations) and tubing (total length=80 inches, diameter=0.25 inches). The EnteraLite Infinity pump uses a rotary peristaltic method for delivery, does not have a collection chamber and is able to infuse in any position once the feeding bag is made airtight. Aliquots for each simulation were labeled as ‘control’ (clear borosilicate glass container; undisturbed during the stimulation), ‘pre-infusion’ (500 mL feeding bag) and ‘post-infusion’ (clear borosilicate glass container).

The initial volume for the control and pre-infusion aliquots was determined as rate×5 hours (hours 0-4) plus 3 mL/sample×3 samples/hour and an additional 15 mL. Accordingly, volumes for the aliquots for 5, 10, 20 and 30 mL/hr simulations were 80, 100, 140, and 180 mL, respectively. Feeding bags were hung at the level of the pump at a height of 40 inches from the ground and post-infusion containers were placed at ground level. All simulations were performed under ambient light and a temperature of 25 degree Celsius.

At the time of sampling, the containers were shaken by hand and 3 mL samples were drawn using a glass pipette at hours 0-4, homogenized, and 1 mL was used to analyze the lipid, carbohydrate, protein (grams/100 mL) and caloric (Kcals/oz.) composition. using the SpectraStar

Near-Infrared Analyzer (Unity Scientific, Columbia, Md., USA). Agitation of a horizontally placed feeding bag was done by placing it on a 55S single platform (11×14 inches) shaker (Reliable Scientific, Inc., MS) and the speed was set at 60-70 rpm orbits/minute to ensure that the entire milk column was agitated.

The feeding bags were secured in an inverted position while infusing by simply taping them securely to the infusion pole (height=40 inches). 249 samples were analyzed in total. Mean (±standard error of mean) values for fat, protein, carbohydrate and total calories were calculated. Percent changes (loss, gain or delivery) compared to control in the macronutrient composition were calculated and reported. Group comparisons were performed using repeated measures analysis of variance (ANOVA) and p<0.05 was considered significant.

Near-Infrared (NIR) analysis of human milk has shown excellent correlation with reference laboratory chemical analysis of macronutrient composition of human milk in prior studies;^{12,13} there was a correlation (r2) between NIR analysis and laboratory analysis of 0.81 for carbohydrate, 0.96 for fat and 0.96 for protein in a study by Sauer et al.¹³

2. Experimental Results

Mean composition (±standard error of mean) of control human milk samples was as follows: fat 3.02±0.04 g/100 mL, protein 0.97±0.01 g/100 mL, carbohydrates 7.36±0.02 g/100 mL and total calories 18.18±0.12 kcals/oz (See table below.).

TABLE 1
Composition of control human milk samples (n = 60).

| | Mean | Standard Error of Mean |
|---|---|---|
| Fat (grams/100 mL) | 3.02 | 0.04 |
| Proteins (grams/100 mL) | 0.97 | 0.01 |
| Carbohydrates | 7.36 | 0.02 |
| (grams/100 mL) | | |
| Calories | 18.18 | 0.12 |
| (Kilocalories/ounce) | | |

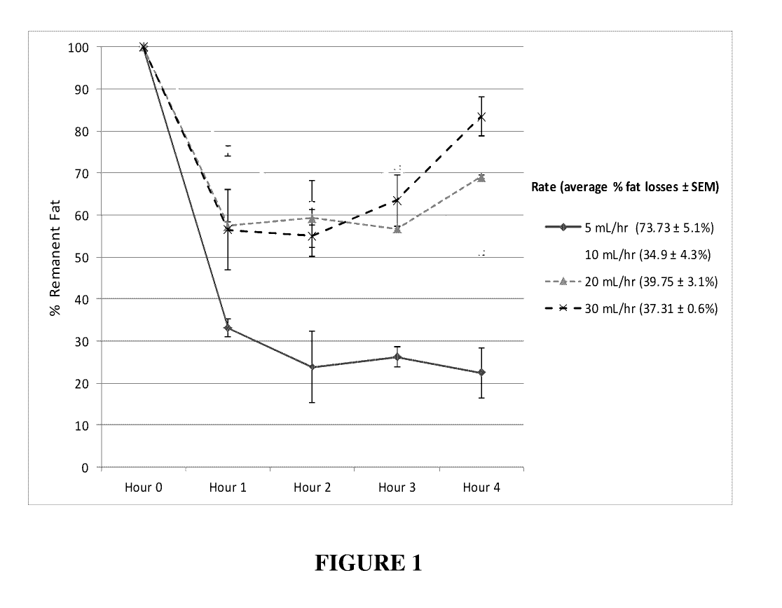

Significant losses of fats (p<0.01) were observed in the post-infusion samples at 5, 10, 20 and 30 mL/hr at hours 1 to 4 when compared to control samples, highest losses being at 5 mL/hour (66.9±2.1% at hour 1, 77.48±6.1% at hour 4; average fat loss over 4 hours: 73.73±5.1%) (FIG. 1). The post-infusion caloric values correlated strongly with the fat losses (Pearson correlation coefficient=0.99, p<0.01) but not with the protein (p=0.51) or carbohydrate content (p=0.86). There were no significant carbohydrates and proteins losses at any infusion rate. Average remnant fat over the 4-hour infusion (delivered to the post-infusion aliquot) was significantly lower at 5 mL/hr. when compared to other rates (p<0.01), but there were no significant differences in the average post-infusion fat content between 10, 20 and 30 mL/hr. (FIG. 1). Maximum fat losses from baseline were seen in the first hour of infusion at all rates (p<0.01).

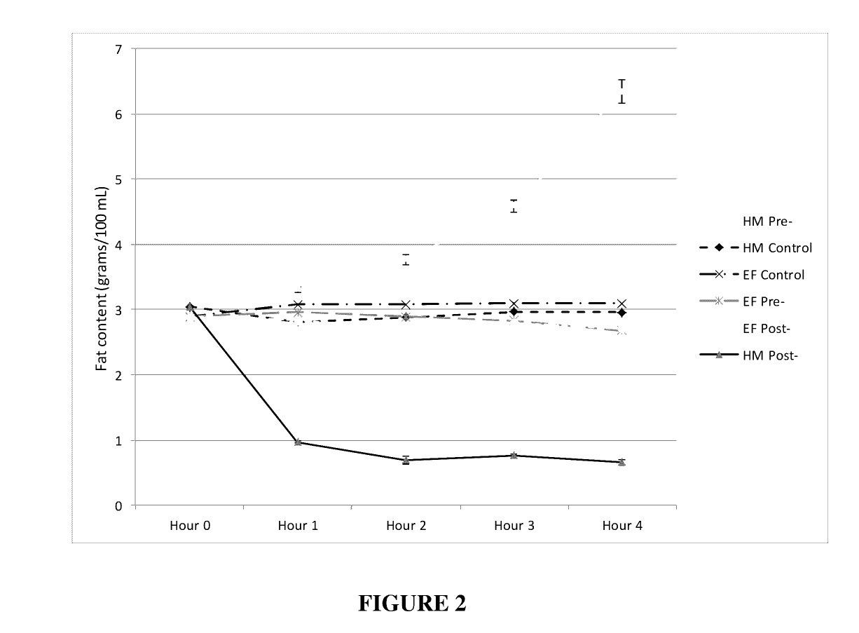

Surprisingly, there was a significant increase in the fat content/hour in the pre-infusion aliquots (feeding bags), with maximum gains seen at 5 mL/hr. (13±1.2% at hour 1, 116.4±2.8% at hour 4; p<0.01 when compared to control) (FIG. 2). Additionally, the rate of infusion was negatively correlated to fat losses (Pearson correlation coefficient=0.56, p<0.05). No losses in any macronutrients or calories were observed with elemental formula feeds at 5 mL/hr.

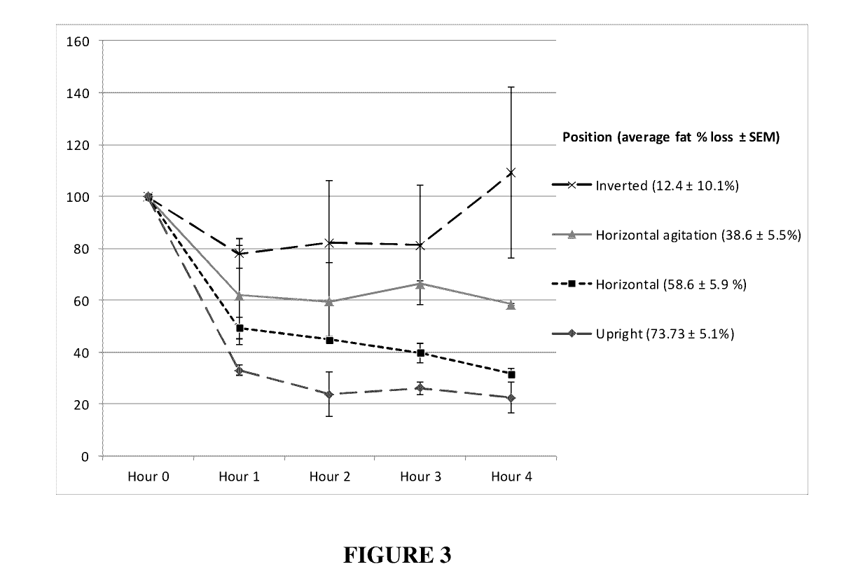

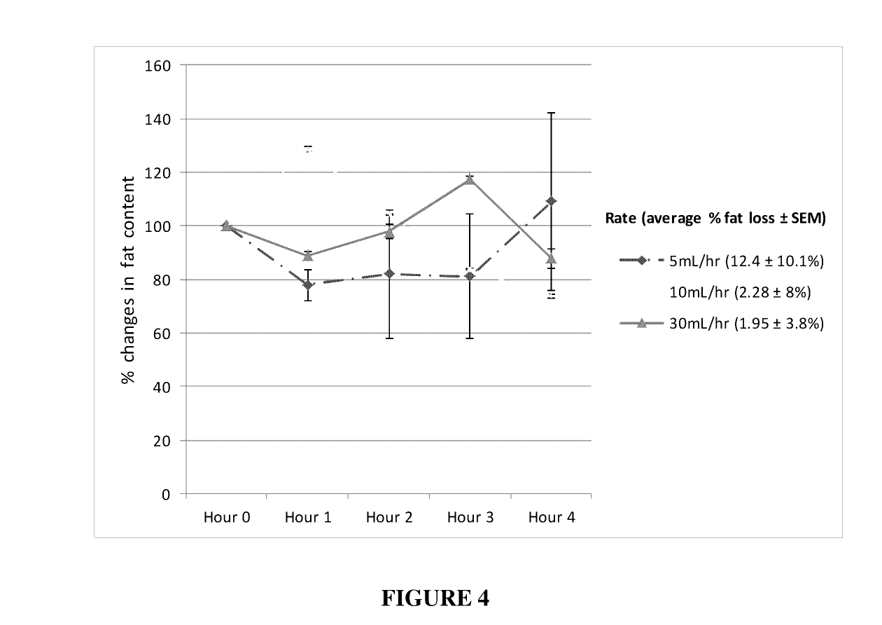

Next, the effects of various positions of the feeding bag on fat delivery were examined while infusing human milk at the rate of 5 mL/hr, since maximum losses were seen at this rate. Significant fat losses (p<0.01) were again observed when the feeding bag was placed in a horizontal position while infusing (average loss over 4 hours: 58.6±5.9%). Continuous agitation of a horizontally placed feeding only partially limited fat loss (average loss over 4 hours: 38.6±5.52%). When simulations were run at 5 mL/hr with the feeding bag in an inverted position, the fat delivery and resultant calorie content was significantly enhanced when compared to other positional changes (average fat delivery: 87.6±11.1%; average caloric content: 94.3±4.9%). The above data is displayed in FIG. 3. Additionally, the fat delivery and caloric content over 4-hours with the infusion bag in the inverted compared to the upright position was significantly higher for higher rates of 10 mL/hr. (average fat delivery: 97.7% vs. 65.1%, p<0.01; average calorie content: 98.8% vs. 84.4% (p<0.01) and 30 mL/hr. (average fat delivery: 98.1% vs. 62.7%, p<0.01, average calorie content: 99% vs. 84.8%, p<0.05) (FIG. 4). Significantly, there were no changes in post-infusion carbohydrate and protein content with positional changes when compared to control samples (See tables below.).

TABLE 2
Mean (±standard deviation of mean) protein content over 4 hours in the post-
infusion aliquots by rate and feeding bag position.

| | Proteins (grams/100 mL)* | | | | | |
|---|---|---|---|---|---|---|
| | 5 mL/hr. | | 10 mL/hr. | | 30 mL/hr. | |
| Control | Upright | Inverted | Upright | Inverted | Upright | Inverted |
| (n = 60) | (n = 12) | (n = 8) | (n = 12) | (n = 8) | (n = 10) | (n = 12) |
| 0.97 ± 0.01 | 1.06 ± 0.03 | 0.98 ± 0.02 | 1.1 ± 0.01 | 0.91 ± 0.02 | 0.99 ± 0.01 | 1.1 ± 0.01 |

*No significant differences were found between pre-infusion (not represented in table) and post-infusion protein contents when compared to their respective controls for all rates and feeding bag positions.

TABLE 3
Mean (±standard deviation of mean) carbohydrate content over 4 hours in the
post-infusion aliquots by rate and feeding bag position.

| | Carbohydrates (grams/100 mL)* | | | | | |
|---|---|---|---|---|---|---|
| | 5 mL/hr. | | 10 mL/hr. | | 30 mL/hr. | |
| Control | Upright | Inverted | Upright | Inverted | Upright | Inverted |
| (n = 60) | (n = 12) | (n = 8) | (n = 12) | (n = 8) | (n = 10) | (n = 12) |
| 0.7.36 ± | 7.05 ± 0.06 | 7.42 ± 0.06 | 7.55 ± 0.04 | 7.46 ± 0.06 | 7.25 ± 0.05 | 7.34 ± 0.04 |
| 0.02 | | | | | | |

*No significant differences were found between pre-infusion (not represented in table) and post-infusion protein contents when compared to their respective controls for all rates and feeding bag positions.

3. Discussion of Experimental Results

Studies have shown benefits of human milk in infants with intestinal insufficiency and therefore it is the recommended mode of nutrition in this patient population.^{6,14} Human milk contains glutamine and growth factors not present in formula, such as growth hormone and epidermal growth factor, which possibly promote bowel adaptation.¹⁵⁻¹⁷The beneficial effects of breast milk are also attributable to its effect on postnatal development of the intestinal microbiome, and its nutrient composition that includes long chain triglycerides, free amino acids, as well as complex proteins and fat.¹⁸ Andorsky et al showed in a retrospective case series of 30 neonates that the use of breast milk was associated with a shorter duration of parenteral nutrition (PN) (mean duration of PN was 290 days in patients receiving breast milk vs. 720 days in non-breast milk-fed patients).¹⁹ In a recent study, human milk as a modality for early enteral nutrition was found to be protective against the development of parenteral nutrition-associated liver disease in infants receiving PN for >4 weeks.²⁰ In spite of existing evidence and recommendations, a recent study found that only 19% of intestinal rehabilitation programs were using human milk.¹⁴ One reason for the lack of use of human milk, even if available and well tolerated by the infant, is the observation that continuous tube feeds result in a loss of lipid and calorie content of human milk and could potentially affect weight gain and growth of the infant, leading to longer hospital stay.^{7-10,21}

The Experimental Example set forth above evaluates macronutrient loss with current feeding practices at various rehabilitation programs and inpatient floors and in the home setting, i.e., continuous tube feedings using a feeding bag attached to a pump. The macronutrient composition of pooled human milk used in this study was similar to prior reports (Table 1).^{11,22}

The Experimental Example showed significant fat and calorie losses in the post-infusion samples when human milk was used. Maximum fat losses, amounting to an average of 73% over the 4-hour infusion, were seen at lower rates of infusion (5 mL/hr.). These results are in agreement with previously conducted studies, most of which utilize syringe pumps.^{7,10,11,23}

Additionally, these studies were intended to replicate NICU practices where feeds are administered over 30-90 minutes rather than in a continuous fashion over a longer period of time (typically over 4 hours). This is of importance since the results of the Experimental Example showed the maximum losses to occur in the first hour of infusion and then reach a plateau (FIG. 1). Moreover, the fat losses observed in the disclosed study are probably greater because unlike syringe pumps, the feeding bags are usually not completely emptied at the end of the infusion.

The Experimental Example did not find any significant losses of protein or carbohydrates in simulations at the rates of 5, 10, 20 and 30 mL/hr. Minimal losses in human milk proteins were demonstrated by Stocks et al in 1985, but the disclosed findings are in agreement with more recent studies.^{1,11} Only one prior study, using 30 mL aliquots infused over 30 minutes, has examined losses of macronutrients with infant formulae and concluded that the fat losses were insignificant.⁷ The Experimental Example shows similar results and, additionally, did not find any protein, carbohydrate or calorie losses using an elemental, amino acid based formula used frequently for patients that require g-tube feeding when infused over 4 hours (FIG. 2).

The loss of fat observed with continuous feeds is generally explained by the theory that when human milk is infused via a tube, fat globules separate and adhere to the plastic surfaces (syringes, extension sets or feeding tubes), a process known as adsorbtion.^{1,23} In the Experimental Example visible fat precipitates were observed, especially around curves in the tubing, and this could certainly explain the loss of fats in the post-infusion aliquots.

Another consequence of the easy separation of fat globules which was observed was that while infusing, the fat quickly separated from the human milk and rose to the top of the feeding bag, forming a visible layer. As a consequence, infusion of fats is limited from conventional feeding bags, where the contents empty from the bottom of the bag. This explains the rising fat content of the feeding bag with each hour of infusion and gains up to 116% of initial fat content were observed at the end of the 4-hour infusion at 5 mL/hr.

The advent of feeding pumps such as those used in this study (EnteraLite Infinity) allow delivery of continuous feeds with the feeding bag in any position once made airtight, enabling the study of delivery of macronutrients, especially fats, with positional changes of the feeding bag. In that respect, even with placing the bag in the horizontal position, it was observed that fat separation in the feeding bag occurred that resulted in relatively lower, but still significant, fat losses over the 4-hour infusion (58.6%). Continuous agitation of a horizontally placed bag was somewhat able to enhance the fat delivery to the post-infusion aliquot by reducing the average losses over 4 hours at 5 mL/hr. to 38.6%. Finally, infusion of human milk with the feeding bag placed in the inverted position, where the contents emptied from the top (rather than the bottom) of the feeding bag, significantly enhanced the delivery of fat (87.6% over 4 hours at 5 mL/hr).

Additionally, with this method, the delivery of fats and calories improved further at the higher rates of 10 and 30 mL/hr (97.7% and 98.1%, respectively), higher than previously reported by studies using various methods, such as addition of emulsifiers (such as lecithin),²⁴ fortification,¹ homogenization²³ and use of modified feeding pumps.²⁵ Prior syringe studies have shown enhanced fat delivery when placed in oblique and horizontal positions.⁹ Hourly, compared to baseline, agitation of the feeding syringe has been shown to somewhat limit fat losses (4% vs. 12%).²³ More recently, Jarjour et al reported improved fat delivery with continuous feeds using a modified version of the existing Kangaroo epump, which incorporates a feeding bag inverter (three inversions over 10 seconds every 3 minutes) and a circulation loop (intended to address fat separation and adherence).²⁵ The delivery of fat at the end of 1 hour improved to 93% from 59% (using the unmodified epump) when both the features were used at 20 mL/hr. Fat delivery exceeding 1 hour was not tested and a single feeding rate of 20 mL/hr was evaluated. The authors also reported additional costs and noise levels associated with the modified epump.

Based on the results of the Experimental Example, the disclosed feeding bag/container wherein the exit port/feeding tube is located at (or near) the top of the bag/container is effective to enhance the delivery of fats during continuous feeds over a longer period of time (4 hour aliquots). There were no differences in the delivery of the protein and carbohydrate content with positional changes of the feeding bags (Tables 2 and 3). The disclosed data provides convincing evidence for use of a top infusing feeding bag/container which could enhance fat delivery even when used at low infusion rates. The simplicity of the proposed method makes it ideal for use in inpatient as well as the home setting. In addition to encouraging more institutions to use human milk as a feeding modality in children that require g-tube feeding, the development of such feeding systems could potentially decrease health care costs for rehabilitation programs by promoting growth and early discharge.

It is noted that the disclosed study is limited to an in-vitro design. Validation of the feasibility and tolerance of feeds with the proposed feeding bag design in the desired patient population is thus needed. Nonetheless, the results set forth in the Experimental Example support an expectation that comparably beneficial results will be achieve in clinical settings. In addition, the Experimental Example did not examine fat adherence to the tubing by washing and analyzing the precipitates. The effect of different tubing materials, length and diameter was not examined in the Experimental Example, although Igawa et al found that fat content pre- and post-infusion was not affected by tube diameter (3, 4, 5 or 6 Fr) or material of the tubing (DEHP-free and PVC-free).⁷

4. Experimental Example—Conclusion

Human milk delivered in a continuous fashion using conventional feeding bags connected to a pump results in high fat and total calorie losses and puts the infant at a risk of growth failure and prolonged hospital stay. These losses may be significantly limited by enabling the delivery of the human milk from (or near) the top, rather than the bottom, of the feeding bag/container, therefore optimizing fat delivery. Such top infusing feeding bags/containers for use in the inpatient and home setting could potentially decrease health care costs for rehabilitation programs by promoting growth and early discharge.

Although the present disclosure has been provided with reference to exemplary embodiments thereof, the present disclosure is not limited by or to such exemplary embodiments. Rather, the present disclosure extends to variations and/or modifications of the disclosed systems and methods, as will be apparent to persons of skill in the art from the disclosure hereof.

### REFERENCES

1. Rogers S P, Hicks P D, Hamzo M, Veit L E, Abrams S A. Continuous feedings of fortified human milk lead to nutrient losses of fat, calcium and phosphorous. Nutrients. 2010; 2(3):230-240.
2. Higgins R D, Devaskar S, Hay W W, Jr, et al. Executive summary of the workshop “nutritional challenges in the high risk infant”. J Pediatr. 2012; 160(3):511-516.
3. Eidelman A I. Breastfeeding and the use of human milk: An analysis of the american academy of pediatrics 2012 breastfeeding policy statement. Breastfeed Med. 2012; 7(5):323-324.
4. Fallon E M, Nehra D, Potemkin A K, et al. A.S.P.E.N. clinical guidelines: Nutrition support of neonatal patients at risk for necrotizing enterocolitis. JPEN J Parenter Enteral Nutr. 2012; 36(5):506-523.
5. Working Group Of Pediatrics Chinese Society Of Parenteral And Enteral, Nutrition, Working Group Of Neonatology Chinese Society Of, Pediatrics, Working Group Of Neonatal Surgery Chinese Society Of Pediatric, Surgery. CSPEN guidelines for nutrition support in neonates. Asia Pac J Clin Nutr. 2013; 22(4):655-663.
6. Olieman J F, Penning C, Ijsselstijn H, et al. Enteral nutrition in children with short-bowel syndrome: Current evidence and recommendations for the clinician. J Am Diet Assoc. 2010; 110(3):420-426.
7. Igawa M, Murase M, Mizuno K, Itabashi K. Is fat content of human milk decreased by infusion? Pediatr Int. 2014; 56(2):230-233.
8. Stocks R J, Davies D P, Allen F, Sewell D. Loss of breast milk nutrients during tube feeding. Arch Dis Child. 1985; 60(2):164-166.
9. Narayanan I, Singh B, Harvey D. Fat loss during feeding of human milk. Arch Dis Child. 1984; 59(5):475-477.
10. Brooks C, Vickers A M, Aryal S. Comparison of lipid and calorie loss from donor human milk among 3 methods of simulated gavage feeding: One-hour, 2-hour, and intermittent gravity feedings. Adv Neonatal Care. 2013; 13(2):131-138.
11. Abranches A D, Soares F V, Junior S C, Moreira M E. Freezing and thawing effects on fat, protein, and lactose levels of human natural milk administered by gavage and continuous infusion. J Pediatr (Rio J). 2014; 90(4):384-388.
12. Corvaglia L, Battistini B, Paoletti V, Aceti A, Capretti M G, Faldella G. Near-infrared reflectance analysis to evaluate the nitrogen and fat content of human milk in neonatal intensive care units. Arch Dis Child Fetal Neonatal Ed. 2008; 93(5):F372-5.
13. Sauer C W, Kim J H. Human milk macronutrient analysis using point-of-care near-infrared spectrophotometry. J Perinatol. 2011; 31(5):339-343.
14. Squires R H, Duggan C, Teitelbaum D H, et al. Natural history of pediatric intestinal failure: Initial report from the pediatric intestinal failure consortium. J Pediatr. 2012; 161(4):723-8.e2.
15. DiBaise J K, Young R J, Vanderhoof J A. Intestinal rehabilitation and the short bowel syndrome: Part 1. Am J Gastroenterol. 2004; 99(7):1386-1395.
16. DiBaise J K, Young R J, Vanderhoof J A. Intestinal rehabilitation and the short bowel syndrome: Part 2. Am J Gastroenterol. 2004; 99(9):1823-1832.
17. Buchman A L, Scolapio J, Fryer J. AGA technical review on short bowel syndrome and intestinal transplantation. Gastroenterology. 2003; 124(4):1111-1134.
18. Levy J. Immunonutrition: The pediatric experience. Nutrition. 1998; 14(7-8):641-647.
19. Andorsky D J, Lund D P, Lillehei C W, et al. Nutritional and other postoperative management of neonates with short bowel syndrome correlates with clinical outcomes. J Pediatr. 2001; 139(1):27-33.
20. Kulkarni S, Mercado V, Rios M, et al. Breast milk is better than formula milk in preventing parenteral nutrition-associated liver disease in infants receiving prolonged parenteral nutrition. J Pediatr Gastroenterol Nutr. 2013; 57(3):383-388.
21. Rogers S P, Hicks P D, Hamzo M, Veit L E, Abrams S A. Continuous feedings of fortified human milk lead to nutrient losses of fat, calcium and phosphorous. Nutrients. 2010; 2(3):230-240.
22. Cooper A R, Barnett D, Gentles E, Cairns L, Simpson J H. Macronutrient content of donor human breast milk. Arch Dis Child Fetal Neonatal Ed. 2013; 98(6):F539-41.
23. Garcia-Lara N R, Escuder-Vieco D, Alonso Diaz C, Vazquez Roman S, De la Cruz-Bertolo J, Pallas-Alonso C R. Type of homogenization and fat loss during continuous infusion of human milk. J Hum Lact. 2014; 30(4):436-441.
24. Chan M M, Nohara M, Chan B R, Curtis J, Chan G M. Lecithin decreases human milk fat loss during enteral pumping. J Pediatr Gastroenterol Nutr. 2003; 36(5):613-615.
25. Jarjour J, Juarez A M, Kocak D K, et al. A novel approach to improving fat delivery in neonatal enteral feeding. Nutrients. 2015; 7(6):5051-5064.

1. A method of delivering breast milk to a recipient, comprising:
a. providing a feeding bag or container that contains the breast milk, the feeding bag or container defining a top and a bottom, and including an exit port or feeding tube positioned at or near the top thereof;
b. dispensing the breast milk from the exit port or feeding tube of the feeding bag or container with the feeding bag or container oriented such that the top of the feeding bag is positioned in a vertically upward orientation.

2. The method of claim 1, wherein the recipient is an infant.

3. The method of claim 2, wherein the infant requires g-tube feeding.

4. The method of claim 1, wherein the breast milk includes macronutrients selected from the group consisting of fat, carbohydrate, and protein.

5. The method of claim 4, wherein greater than 70% of the fat calories from the breast milk are dispensed from the feeding bag or container to the recipient.

6. The method of claim 1, wherein the feeding bag or container is airtight and the breast milk is dispensed therefrom by application of pressure.

7. The method of claim 1, wherein the breast milk is dispensed from the feeding bag or container based on pump operation.

8. A breast milk feeding bag or container, comprising:
a. a feeding bag defining a volume, a top and a bottom; and
b. a dispensing tube in fluid communication with the volume of the feeding bag at or near the top of the bag, wherein the breast milk located at the top of the bag will be consumed first.

9. The feeding bag or container of claim 8, further comprising a strap associated with the feeding bag that facilitates hanging thereof.

10. The feeding bag or container of claim 8, wherein the bag is filled and sealed from the top.

11. The feeding bag or container of claim 8, wherein the dispensing tube is suspended at the apex of a semicircle loop so as to avoid kinking.

12. The feeding bag or container of claim 8, wherein the dispensing tube is surrounded with a flexible metal coil so as to avoid kinking.

13. The feeding bag or container of claim 12, wherein the flexible metal coil is a flexible spring.

14. The feeding bag or container of claim 8, wherein the bag is air-tight and the breast milk is drawn out via pressure.

15. The feeding bag or container of claim 8, wherein the bag is made of a collapsible material.
